(19) United States
(12) Patent Application Publication
(10) Pub. No.: US 2005/0183267 A1
(43) Pub. Date: Aug. 25, 2005

(54) Electric shaver

(75) Inventor: Masaki Okabe, Matsumoto (JP)

Correspondence Address: KODA & ANDROLIA, 2029 CENTURY PARK EAST, SUITE 1140, LOS ANGELES, CA, 90067, US

(73) Assignee: IZUMI PRODUCTS COMPANY

(21) Appl. No.: 11/060,523

(22) Filed: Feb. 17, 2005

(30) Foreign Application Priority Data
Feb. 19, 2004 (JP) 2004-42659

(51) Int. Cl. B26B 19/02

(52) U.S. Cl. 30/43.92

(57) ABSTRACT

An electric shaver in which a plurality of mutually separated cutter blades provided in an inner cutter are moved in relative terms while making sliding contact with an outer cutter that is formed with a plurality of hair introduction openings, so that hair that enters into the hair introduction openings of the outer cutter is cut by the cutter blades, wherein the cutter blades are caused to intersect the same hair introduction openings of the outer cutter at different angles.

### BACKGROUND OF THE INVENTION

1. Technical Field

The present invention relates to an electric shaver and more particularly to an electric shaver in which a plurality of mutually separated cutter blades of an inner cutter moves in relative terms while making sliding contact with an outer cutter that has a plurality of openings, so that hair that has entered into the openings of the outer cutter is cut by the cutter blades of the inner cutter.

2. Description of the Related Art

In electric shavers that include outer cutters and inner cutter, the inner cutter makes a reciprocating motion (in a reciprocating type shaver) or rotates (in a rotary type shaver or in a dome type shaver) with respect to a fixed outer cutter. One type of conventional inner cutter includes cutter blades that have the same shape and are separated from each other as disclosed in, for instance, Japanese Patent Application Publication (Kokoku) Nos. S61-61829 and S57-53485. In these prior art inner cutters, a plurality of separated cutter blades intersect the openings (hair introduction openings) of the outer cutter at the same angle.

In another type of conventional inner cutter, the cutter blades are integrated without being separated from each other as disclosed in, for instance, Japanese Patent Application Publication (Kokoku) Nos. S57-30018, H8-17857 and S60-9597 and Japanese Patent Application Laid-Open (Kokai) No. S59-103690. In such inner cutters in which the cutter blades are integrated, diamond-shaped openings are formed by fine straight elements that cross each other with different inclinations.

In an inner cutter that includes a plurality of cutter blades integrally formed so that the inner cutter has the diamond-shaped openings, there are several problems. Shaving debris and skin oils tend to adhere to the areas between the cutter blades, and they tend to adhere especially to the corners of the diamond-shaped openings, and these substances are difficult to remove. In an inner cutter that is formed with mutually separated cutter blades, large spaces are formed between the respective cutter blades, so that shaving debris and the like can easily drop through these spaces; furthermore, since the respective cutter blades can easily vibrate, the dropping of such shaving debris can be promoted by the vibration.

However, in the inner cuter that has such separated cutter blades, all of the cutter blades are perpendicular to the direction of the reciprocating motion of the inner cutter or the inclination of these cutter blades is fixed. Accordingly, the hair that enters the openings of the outer cutter is cut by the narrow range of the edges of the openings; as a result, the wear of the portion that is used to cut the hair (within the total range of the edges of the openings in the outer cutter) is rapid, and the durability is low. This problem will be explained in greater detail with reference to a reciprocating electric shaver and to FIGS. 16 through 18.

FIG. 16 illustrates, in cross-sectional manner, the inner cutter 10 and outer cutter 12 taken along a plane that is parallel to the direction a of the reciprocating motion of the inner cutter 10.

A plurality of openings 14 are formed in the outer cutter 12 so that hair is introduce hair into the outer cutter through the openings 14, and the cutter blades 16 of the inner cutter 10 make a reciprocating motion in the direction a beneath the openings 14 of the outer cutter 12. The outer cutter 12 and inner cutter 10 are both formed by bending thin plates into an arch shape, and FIGS. 17A and 17B show the inner cutters 10A and 10B unfolded into a planar shape.

The inner cutter 10A shown in FIG. 17A is comprised of a plurality of mutually separated cutter blades 16A and side edge portions 18. The cutter blades 16A extend perpendicular to the direction a of the reciprocating motion of the inner cutter 10A, and the side edge portions 18 connect both ends of these cutter blades 16A. In the inner cutter 10B shown in FIG. 17B, the cutter blades 16B are inclined at a fixed angle (not including the right angles) with respect to the direction a of the reciprocating motion of the inner cutter 10B.

FIGS. 18A through 18C illustrate the manner of cutting hair by the openings 14 of the outer cutter 12 and by the cutter blades 16A of the inner cutter 10A. In FIGS. 18A through 18C, the manner of cutting the hair will be described with the cutter blades 16A shown in FIG. 17A in which the cutter blades 16A are perpendicular to the direction a of the reciprocating motion of the inner cutter 10A. FIGS. 18A and 18B respectively show the openings 14A and 14B of the outer cutter which are in a hexagonal shape with variations of 60°. The opening(s) 14C of the outer cutter shown in FIG. 18C is formed in the shape of a parallelogram with rounded corners.

In FIG. 18A, two corners of the hexagonal opening that are on both sides of the shorter edges are positioned on both sides in the direction a of the reciprocating motion, while in FIG. 18B, two corners of the hexagonal opening that are on both sides of the shorter edges are positioned in a direction perpendicular to the direction a of the reciprocating motion. In this structure, the hair 20 that is introduced and advances into the openings 14A or 14B is pressed by the cutter blades 1 6A and cut by being nipped between the inside edges of the hexagonal opening in the direction a of the reciprocating motion (the advancing direction of the cutter blades 16A) and the cutter blades 16A. In FIGS. 18A and 18B, though the ranges defined by b are used to cut the hair, the ranges defined by c are not used. Likewise, in the case of openings 14C shown in FIG. 18C, though the range defined by b is used, the range defined by c is not used. In the case of the inner cutter 10B shown in FIG. 17B, the cutter blades 16B thereof are inclined and thus merely differ from the cutter blades 16A in the direction in cutter blades extend. Accordingly, though the ranges defined by b and c may differ from those shown in FIGS. 18A and 18B in size, the range of the opening used during cutting the hair is substantially the same in size as the cases shown in FIGS. 18A and 18B.

The inner edges of the openings 14A, 14B and 14C form the cutting edges around the entire circumference. In actuality, however, since the range b that is used for cutting is limited, the wear of the cutting edge in this range b is accelerated compared to the case in which the entire circumference of the inner edge of each opening 14 is used for cutting, so that the sharpness of the cutting edge quickly deteriorates. In other words, the durability of the outer cutter tends to drop easily.

### SUMMARY OF THE INVENTION

The present invention was made in light of the problems described above.

It is, therefore, an object of the present invention to provide an electric shaver that includes an inner cutter that has mutually separated cutter blades and an outer cutter that has an expanded range of inner edge of the opening (hair introduction opening) which is used to cut hair, so that the burden on a specified range of edges of the hair introduction openings of the outer cutter is lightened, the outer cutter has good cutting sharpness over a long period of time with an improved durability and further has prolonged useful life.

The above object is accomplished by a unique structure of the present invention for an electric shaver in which a plurality of mutually separated cutter blades provided in an inner cutter are caused to move in relative terms while being caused to make sliding contact with an outer cutter that is formed with a plurality of hair introduction openings, so that hair that is introduced into the hair introduction openings of the outer cutter is cut by the cutter blades; and in the present invention, the cutter blades are provided so that they cross or intersect the same hair introduction openings of the outer cutter at different angles.

In the above structure, when the inner cutter makes reciprocating or rotational movements, the plurality of separated cutter blades of the inner cutter intersect the same position in the same hair introduction opening of the outer cutter at different angles; accordingly, the hair is cut in a different range of the edge of the hair introduction opening of the outer cutter by different cutter blades. As a result, the burden on a specified narrow range of the edges of the hair introduction openings of the outer cutter is low, and a wide range of the edges of the hair introduction openings is used for cutting the hair. As a result, a good sharpness is maintained for a long period of time, improving the durability of the outer cutter and lengthening the useful life.

In the present invention, the angle (nipping angle) at which the hair is nipped or held when the hair is cut by the cutter blades of the inner cutter and the edges of the hair introduction opening of the outer cutter varies for each different cutter blade, and it is desirable to set the angles of the cutter blades so that the hair nipping angle is in the optimal range for cutting the hair. In other words, it is advisable to vary the angle of the cutter blades within a range that allows oblique cutting without causing any movement of the hair.

The present invention is applicable to electric shavers of various types including a reciprocating shaver, a rotary shaver, a dome type shaver and the like. For a reciprocating electric shaver, the cutter blades of the inner cutter are designed so that the blades have a plurality of bent regions that have different inclinations with respect to the direction of the reciprocating motion of the inner cutter, and in addition, the changeover positions of these bent regions can be different in adjacent cutter blades.

In the above structure, the changeover positions of the bent regions of the respective cutter blades can be arranged on a straight line that inclines with respect to the direction of the reciprocating motion of the inner cutter or can be arranged on a curved line that substantially undulates in the direction of the reciprocating motion of the inner cutter. Furthermore, in the present invention, adjacent cutter blades next to each other can be formed with deformed portions so that the width of the deformed portions of one blade cutter is different from the width of the deformed portion of the other blade cutter.

In addition, the deformed portions can be a substantially circular shape, a substantially circular ring shape, a substantially diamond shape or a substantially diamond-form ring shape. Further, the shapes of adjacent cutter blades can be completely different from each other. For example, one of two adjacent cutter blades (one of two cutter blades that make a pair) is formed with a substantially rectilinear shape or a substantially triangular wave shape that is substantially perpendicular to the direction of the reciprocating motion of the inner cutter, while the other cutter blade is formed with deformed portions whose width in the direction of the reciprocating motion of the inner cutter varies.

### BRIEF DESCRIPTION OF THE DRAWINGS

FIG. 1 is a schematic front view of the internal structure of a reciprocating electric shaver according to one embodiment of the present invention;

FIG. 2 is a schematic side view thereof;

FIGS. 3A through 3C are explanatory diagrams of the principle of the present invention;

FIG. 4 is an explanatory diagram of the principle of the present invention;

FIG. 5 is an unfolded view of the inner cutter according to the present invention;

FIG. 6 is an unfolded view of the inner cutter according to the present invention;

FIG. 7 is an unfolded view of the inner cutter according to the present invention;

FIG. 8A is an unfolded view of the inner cutter of the present invention, and FIG. 8B shows the cutter blades thereof;

FIG. 9A is an unfolded view of the inner cutter of the present invention, and FIG. 9B shows the cutter blades thereof;

FIG. 10A is an unfolded view of the inner cutter of the present invention, and FIG. 10B shows the cutter blades thereof;

FIG. 11A is an unfolded view of the inner cutter of the present invention, and FIG. 11B shows the cutter blades thereof;

FIG. 12 is a sectional view of the shave head of a rotary type electric shaver according to the present invention;

FIGS. 13A and 13B illustrate the shapes of the cutter blades of the inner cutter thereof;

FIG. 14 is a sectional view of the shaver head of a dome type electric shaver according to the present invention;

FIG. 15 is a top view showing the shape of the cutter blades of the inner cutter used in the dome type electric shaver of FIG. 14;

FIG. 16 is an explanatory diagram showing the layout of the outer cutter and inner cutter of prior art;

FIGS. 17A and 17B show the inner cutters of prior art unfolded; and

FIGS. 18A through 18C are explanatory diagrams showing the hair cutting operation by a prior art shaver.

### DETAILED DESCRIPTION OF THE INVENTION

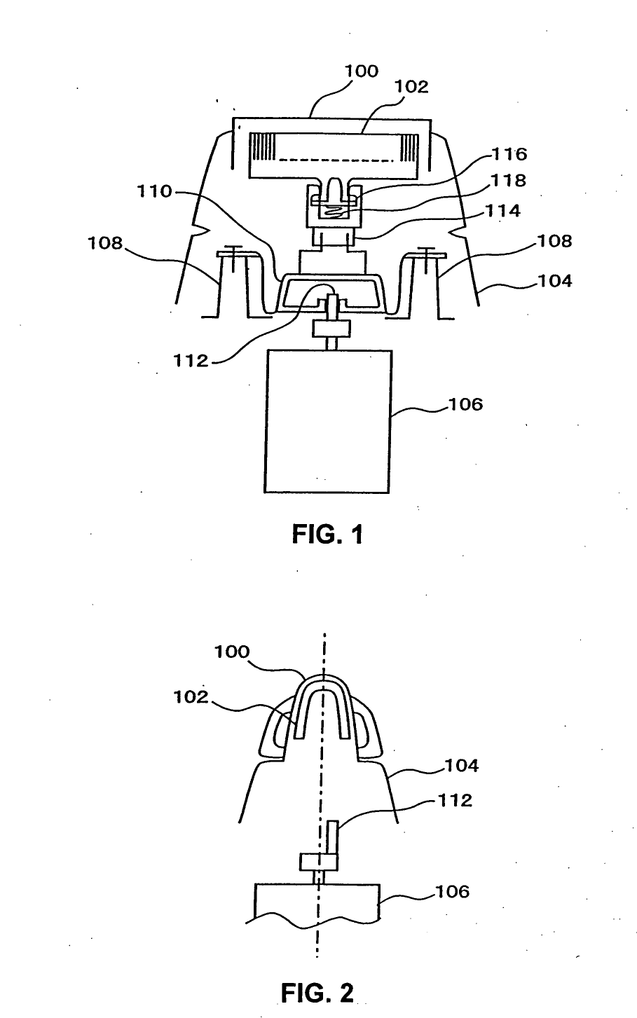

FIG. 1 schematically shows the internal structure of a reciprocating electric shaver according to one embodiment of the present invention, the internal structure of the shaver body being omitted; and FIG. 2 schematically shows the shaver seen from the side.

In FIGS. 1 and 2, the reference number 100 is an arch-shaped outer cutter, and 102 is an arch-shaped inner cutter that makes a reciprocating motion within or under the outer cutter 100. The outer cutter 100 is fastened to a frame 104 of the shaver body (not shown). The outer cutter 100 is made of a thin plate of stainless steel, etc., and a plurality of openings (hair introduction openings) are formed in this thin metal plate by, for instance, press-stamping or etching. The outer cuter 100 can be made by electro-casting.

The inner cutter 102, which, like the outer cutter 100, is made of a thin plate of stainless steel, etc., is driven in a reciprocating motion by an electric motor 106. More specifically, a plane oscillator 110 made of a synthetic resin is suspended from the upper end surfaces of a pair of supporting columns 108 that extend in an upright attitude from the frame 104 so that the oscillator 110 is free to oscillate laterally (or to the left and right in FIG. 1), and a crank pin 112 that is fastened to the rotating shaft of the motor 106 is engaged with an elongated groove formed in the oscillator 110. As a result, when the rotating shaft of the motor 106 installed in the shaver body rotates, the oscillator 110 makes a lateral (or left and right) reciprocating motion.

A supporting column 114 is provided to protrude from the oscillator 110, and a holding portion 116 for the inner cutter 102 is held on the supporting column 114. The holding portion 116 is guided by the supporting column 114 so that the holding portion 116 is free to make a upward and downward motion; and a return inertia oriented in the upward direction toward the outer cutter 100 is applied to the holding portion 116 by a coil spring 118. As a result, the inner cutter 102 is driven in a reciprocating fashion by the motor 106 while being held in elastic contact with the inside surface of the outer cutter 100 by the coil spring 118.

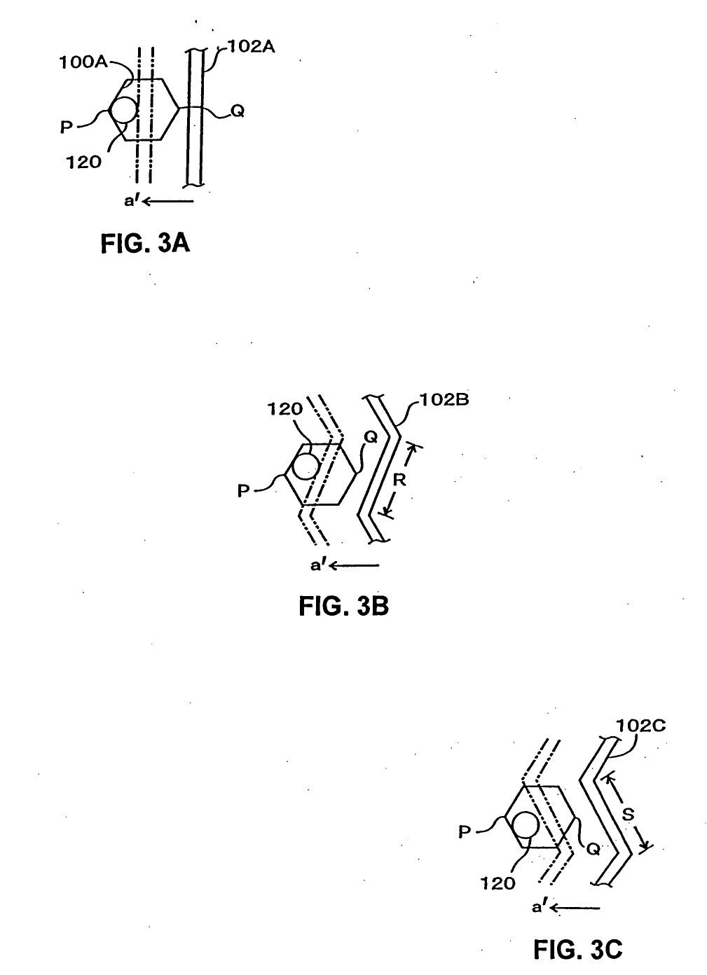

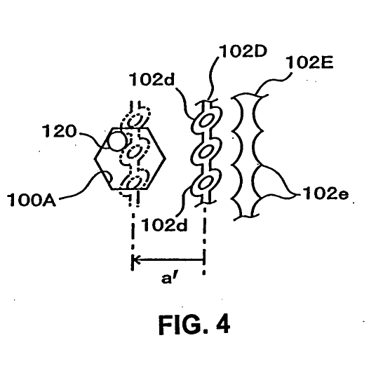

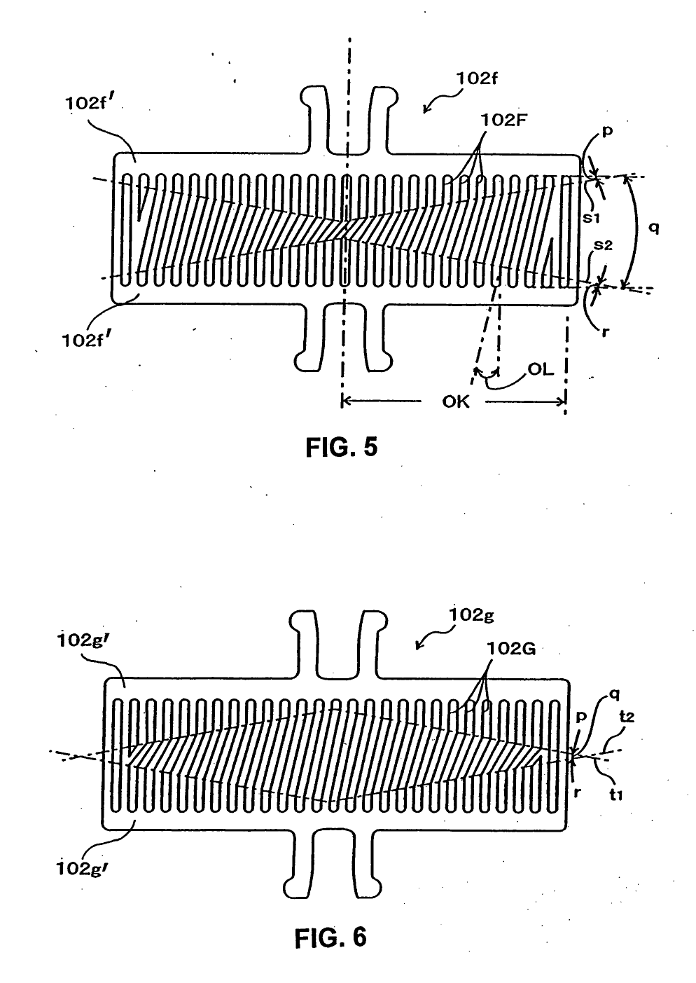

Next, the principle of the present invention will be described with reference to FIG. 3A through FIG. 4.

In FIG. 3A through FIG. 4, the reference number 100A refers to one of the hair introduction openings formed in the outer cutter 100. The hair introduction opening of this embodiment has a hexagonal shape; and in this hexagonal hair introduction opening 100A, a pair of the vertices (P, Q) of the hexagonal shape are positioned on a straight line in the direction a of the reciprocating motion the inner cutter 102 makes (the direction a of the reciprocating motion of the inner cutter will be called occasionally a “lateral direction of the inner cutter”).

The reference numbers 102A through 102E refer to the cutter blades formed in the respective inner cutters. The cutter blade 102A is in a rectilinear shape that extends perpendicular to the direction a of the reciprocating motion of the inner cutter 102. The cutter blades 102B and 102C are of a substantially triangular wave shape having bent regions R and S that are substantially parallel to the two sides located on both sides of the vertex P of the hair introduction opening 100A of the outer cutter.

A description will be made for the case in which the three cutter blades 102A, 102B and 102C move in the same direction, i.e., to the left in FIG. 3 as shown by arrows a′. In the state shown in FIG. 3A, hair 120 that advances into the hair introduction opening 100A of the outer cutter is held against the vertex P and cut by the cutter blade 102A that is straight. In the state shown in FIGS. 3B and 3C, the hair 120 is held against the two sides on both sides of the vertex P and cut by the cutter blades 102B and 102C. As a result, the hair 120 is cut utilizing the vertex P of the hair introduction opening 100A and the two sides on both sides of this vertex.

In the case of an inner cutter that has only the straight cutter blade(s) 102A shown in FIG. 3A, since hair 120 is constantly cut using the vertex P of the hair introduction opening 100A, the frequency of use of the vertex P is great, and the wear of the cutting edge of this vertex P progresses -rapidly, resulting in that the useful life of the outer cutter is shortened. On the other hand, in cases where the cutter blade is designed so that two or more cutter blades, which have different inclinations with respect to the same hair introduction opening 100A, intersect this same hair introduction opening 100A, the frequency of use of the vertex P is less, and a greatly extended useful life of the outer cutter 100 is assured. In other words, with an inner cutter that has the cutter blades 102A and 102B or with an inner cutter that has the cutter blades 102A and 102C, since such cutter blades, which have different inclinations with respect to the same hair introduction opening 100A, intersect this same hair introduction opening 100A, the frequency of use of the vertex P is less, and a greatly extended useful life of the outer cutter 100 is assured.

FIG. 4 shows a cutter blade in which two adjacent cutter blades 102D and 102E have different shapes, so that the angle at which the respective cutter blades 102D and 102E intersect the same position of the edge of the hair introduction opening 100A varies.

More specifically, the widths of the cutter blades 102D and 102E in the lateral direction of the inner cutter differ from each other with respect to the direction of length; and deformed portions 102d having a substantially oval ring shape are formed in the cutter blade 102D, and deformed portions 102e having a wave shape are formed in the cutter blade 102E.

These cutter blades 102D and 102E formed in a single inner cutter make a reciprocating motion as a unit; and since the different regions of the cutting edge of the hair introduction opening 100A are used when the cutter blades 102D and 102E cut the hair 120, the cutting edge of the hair introduction opening 100A is able to have an extended useful life.

FIGS. 5 through 7 illustrate the inner cutters of another embodiment of the present invention used in the reciprocating electric shaver shown in FIGS. 1 and 2, the inner cutters being shown in an unfolded manner. In other words, FIGS. 5 through 7 show thin plates of the inner cutters 102f, 102g and 102h unfolded into a planar configuration.

The inner cutters 102f, 102g and 102h of FIGS. 5 through 7 are, respectively, formed with cutter blades 102F, 102G and 102H. These cutter blades 102F, 102G and 102H are formed by making a plurality of elongated openings in a thin metal plate by for instance, press-stamping or etching, so that the elongated metal sections remain between the openings, and such remaining sections make the cutter blades 102F, 102G and 102H. Thus, each one of the inner cutters 102f, 102g and 102h is comprised of a plurality of mutually separated cutter blades 102F, 102G and 102H and side end portions 102f′, 102g′ and 102h′ that connect both ends of the cutter blades. Though not described in detail, the inner cutters shown in FIGS. 3A through 4 have substantially the same structure as that described above with reference to FIGS. 5 through 7 and are respectively comprised of a plurality of mutually separated cutter blades (102A through 102E) and side end portions that connect both ends of these cutter blades.

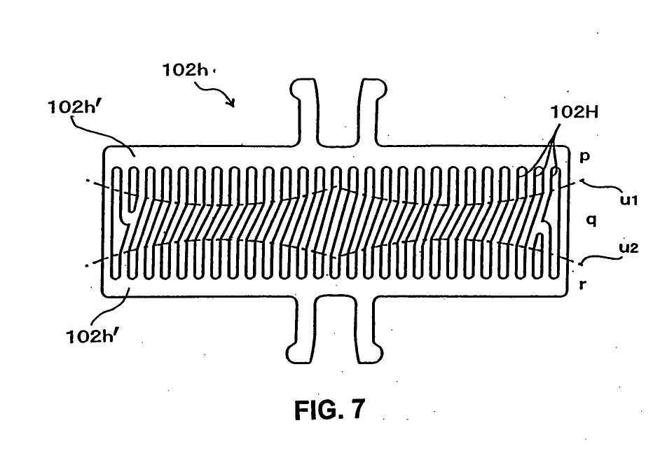

The cutter blades 102F, 102G and 102H of the inner cutters 102f, 102g and 102h shown in FIGS. 5, 6 and 7 respectively have a plurality of bent regions (i.e., three bent regions) p, q and r that have different inclinations with respect to the lateral direction of the inner cutters 102f through 102h. More specifically, as to the central bent region q, the inclination of the respective cutter blades 102F through 102H (i.e., the angle indicated by line OL in FIG. 5) differs within the range (the range indicated by OK in FIG. 5) on both sides of the center in the lateral direction or in the direction of the reciprocating motion of the inner cutters 102f through 102h. In other words, the cutter blades 102F which are in the region q and near the center of the inner cutter 102f of FIG. 5 have a larger angle of inclination compared to the angle of inclination of the cutter blades 102F at both lateral ends of the region q. On the other hand, the angle of inclination of the cutter blades 102G which are in the region q and near the center of the inner cutter 102g of FIG. 6 is smaller than the angle of inclination of the cutter blades at both lateral ends of the region q. As to the cutter blades 102H which are in the region q of the inner cutter 102h of FIG. 7, the region q is comprised of two areas on both sides of the center, and the cutter blades on both lateral ends of each one of the areas have a smaller angle of inclination compared to the cutter blades near the center of each areas. Furthermore, the cutter blades 102F through 102H in the regions p and r on both sides of the region q of each one of the inner cutters 102f through 102g are perpendicular to the lateral direction of the inner cutters 102f through 102g.

In the cutter blades shown in FIG. 5, the changeover positions of the bent regions p, q and r are located on substantially V-shape straight lines s1 and s2 that close inwardly in the vicinity of the center of the inner cutter 102f. In the cutter blades shown in FIG. 6, the changeover positions are on the substantially V-shape straight lines t1 and t2 that open outwardly in the vicinity of the center of the inner cutter 102g. In other words, the changeover positions of the plurality of bent regions are located on straight lines that are inclined with respect to the lateral direction of the inner cutter or to the direction a of the reciprocating motion of the inner cutter. In the cutter blades shown in FIG. 7, the changeover positions are located on gentle, substantially waveform curves u1 and u2. In other words, in the cutter blades shown in FIG. 7, the changeover positions of the bent regions are located along curved lines that extend in the lateral direction of the inner cutter or in the direction a of the reciprocating motion of the inner cutter.

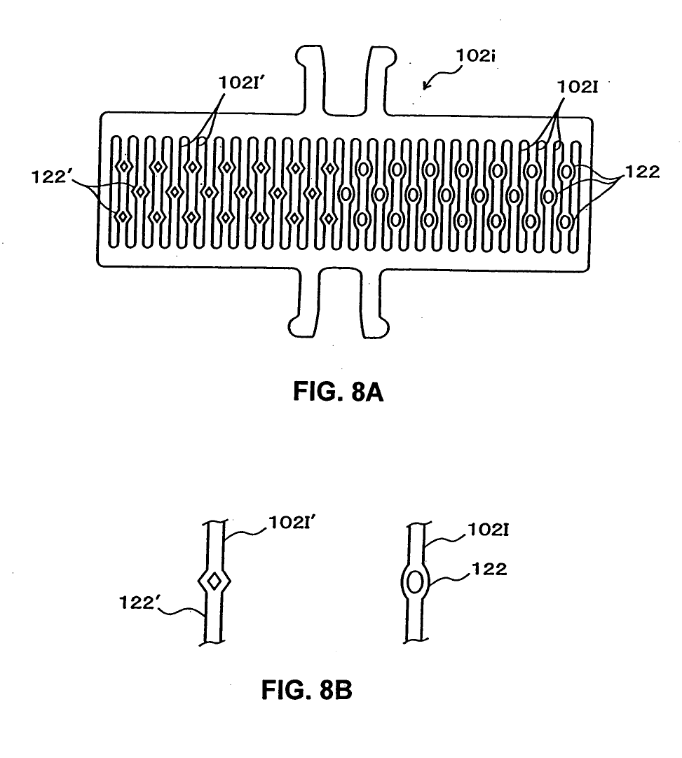

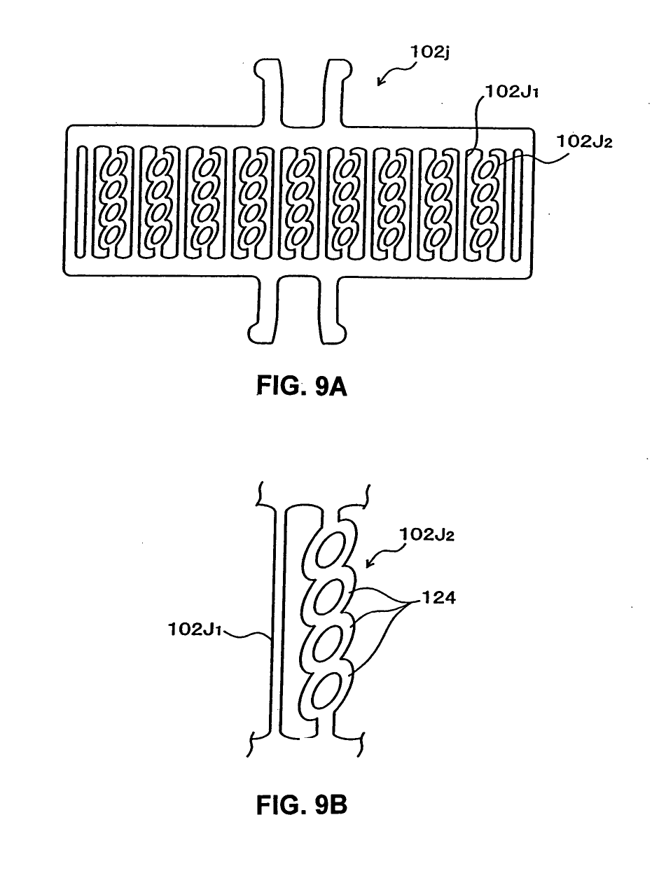

FIGS. 8A and 8B show the inner cutter of a still another embodiment of the present invention.

In the inner cutter 102i shown in FIG. 8A, the deformed portions 122 are formed in the cutter blades 12I so that the width of the deformed portions 122 in the lateral direction of the inner cutter differ from the width of the cutter blades, and the cutter blades are formed so that the locations of the deformed portions 122 vary in the direction of length (the direction perpendicular to the lateral direction) of the adjacent cutter blades. In other words, the deformed portions 122 are arranged in a zigzag pattern.

FIG. 8A shows the inner cutter 102i unfolded, and FIG. 8B shows the deformed portions 122 of the cutter blades enlarged. The deformed portions 122 of the cutter blades 102I shown in the right half of FIG. 8A have a substantially oval ring-form shape, while the deformed portions 122′ of the cutter blades 102I′ shown in the left half of FIG. 8A have a substantially diamond-shaped ring-form shape. In the shown inner cutter 102i, the shapes of the cutter blades 102I and 102I′ differ in the left and right halves; however, this is merely an expression of two different shapes of the deformed portions of two separate inner cutters in a single figure for convenience. Nonetheless, the inner cutter of the present invention can be provided with cutter blades that have substantially oval ring-form shape deformed portions in one side (for instance, in the left half) and substantially diamond-shaped deformed portions in the other side (for instance, in the right half).

FIGS. 9A and 9B show a still another embodiment of the present invention.

FIG. 9A shows the inner cutter 102j unfolded, and FIG. 9B shows the deformed portions 124 of the cutter blades enlarged. As seen from FIGS. 9A and 9B, in this embodiment, one cutter blade 102J₁ of two (or a pair of) adjacent cutter blades 102J₁ and 102J₂ has a rectilinear shape that is substantially perpendicular to the lateral direction of the inner cutter 102j, while the other cutter blade 102J₂ of the two has a shape that is formed by connecting deformed portions 124 that have a substantially oval ring-form shape.

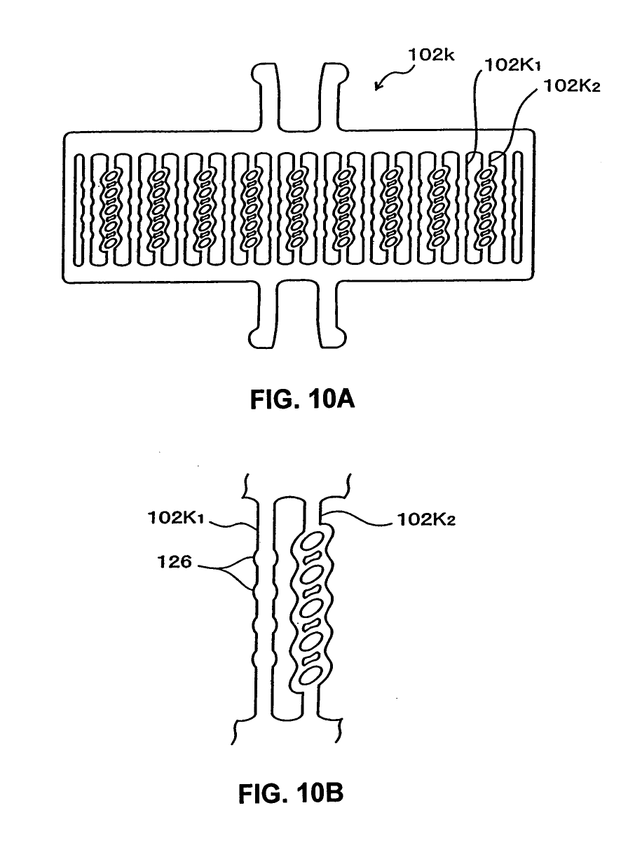

FIG. 10A shows another type of inner cutter 102k unfolded, and FIG. 10B shows two adjacent cutter blades enlarged. In this inner cutter, one cutter blade 102K₁ of two (or a pair of) adjacent cutter blades 102K₁ and 102K₂ has deformed portions 126 that bulge outward (i.e., that have an expanded width) with intervals in between in the direction of the length (in other words, the deformed portions 126 are formed in the cutter blade 102J₁ shown in FIGS. 9A and 9B), while the other cutter blade 102K₂ has a shape formed by oval rings connected together with empty spaces left between the rings.

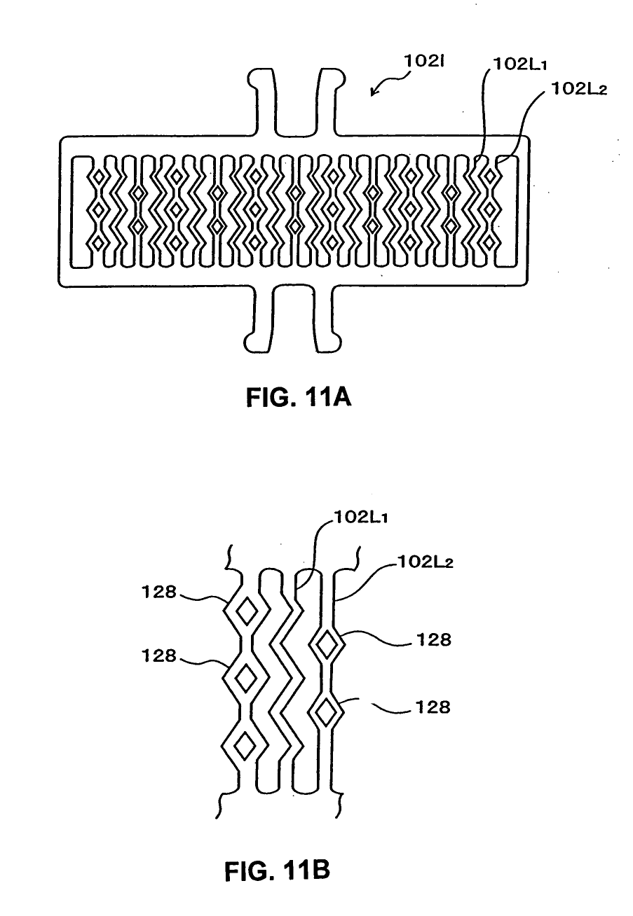

FIG. 11A shows still another type of inner cutter 102I unfolded, and FIG. 11B shows three adjacent cutter blades enlarged. In this inner cutter, one cutter blade 102L₁ of two (or a pair of) adjacent cutter blades 102L₁ and 102L₂ is formed in a shape that is bent into a substantially triangular wave-form shape, while the other cutter blade 102L₂ has deformed portions 128 that have a substantially diamond-shaped ring-form shape. The protrusions of the diamond-shaped deformed portions 128 are formed so as to face the bent indented portions of the adjacent wave-form shape cutter blades 102L₁, so that the gap between the cutter blades 102L₁ and 102L₂ is maintained at a substantially constant distance.

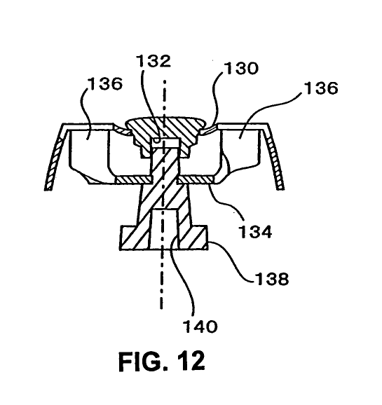

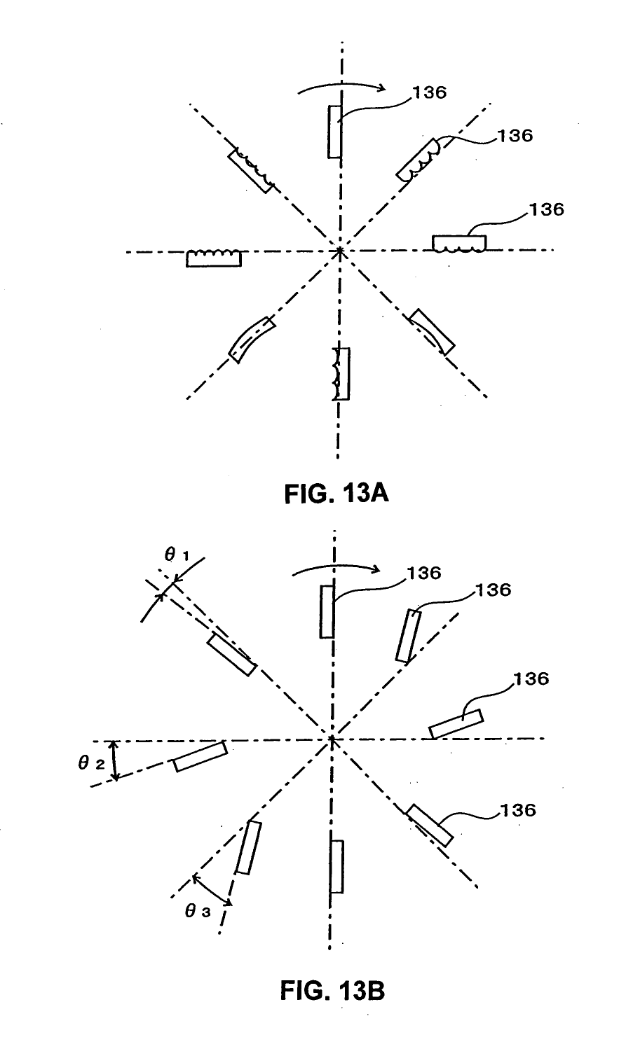

FIG. 12 shows in cross section one of a plurality of (three, for instance) cutter units comprising an outer cutter and an inner cutter in a rotary type electric shaver on which the present invention is applied, and FIG. 13 shows the cutter blades of the inner cutter used in this cutter unit, particularly showing the shape of the cutter blades enlarged.

In FIG. 12, the reference number 130 is an outer cutter which has a shape of substantially a cylinder having a closed top, and a plurality of slits (elongated-shape hair introduction openings, not shown) are formed in a radial pattern in the top of this circular outer cutter 130. A bearing hole 132 that opens toward the inside (underside) is formed in the center of this outer cutter 130.

The reference number 134 is an inner cutter of a circular shape; and in this inner cutter, a plurality of mutually separated cutter blades 136 are formed substantially in a flower-petal configuration. A shaft member 138 made of a synthetic resin is passed through the center of the inner cutter 134 and fastened to this inner cutter 134. A drive shaft engaging hole 140 is formed in the lower part of the shaft member 138, and the drive shaft of a motor (both not shown) is engaged with this shaft engaging hole 140 so as to rotate the inner cutter 134. The upper end of the shaft member 138 is engaged in the bearing hole 132 of the outer cutter 130, so that axial oscillation of the inner cutter 134 is prevented.

As shown in FIGS. 13A and 13B, the inner cutter 134 has eight cutter blades 136 which are provided at equal intervals in the circumferential direction. The shape of the cutting edges of the cutter blades 136 that are adjacent to each other in the circumferential direction are formed so as to be different from each other. The cutter blades 136 shown in FIG. 13A have substantially wave-form cutting edges, and the size or shape of the wave of one cutter blade 136 is different from that of the next cutter blade 136. In the inner cutter shown in FIG. 13B, all the cutter blades 136 have rectilinear cutting edges, and these blades are disposed so that the angle θ in the radial direction is different in adjacent cutter blades 136. In other words, the angle θ varies from 0 to θ3.

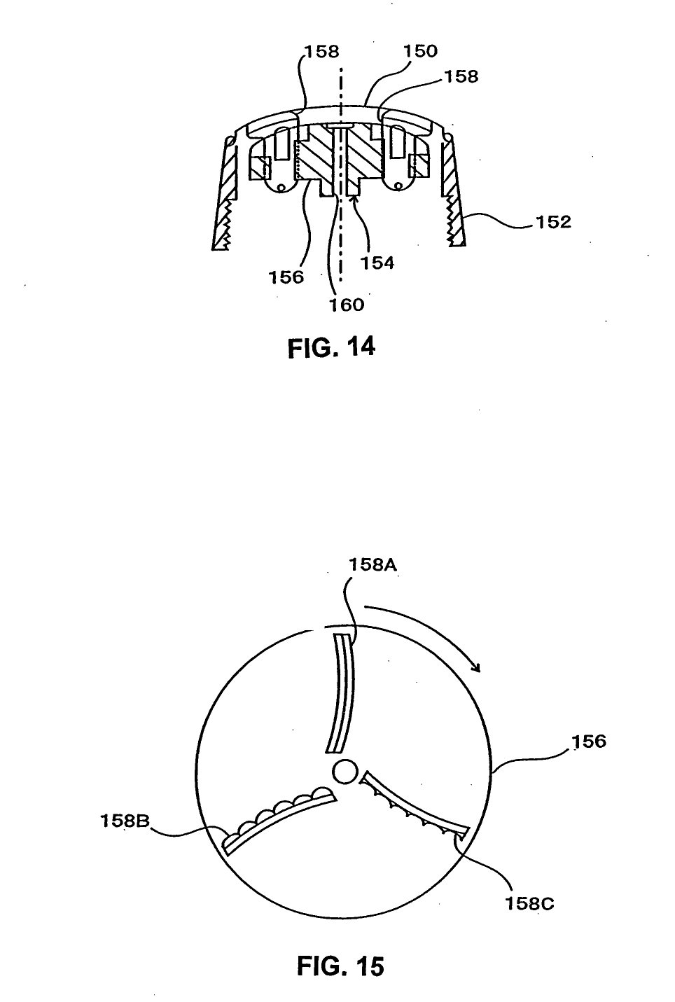

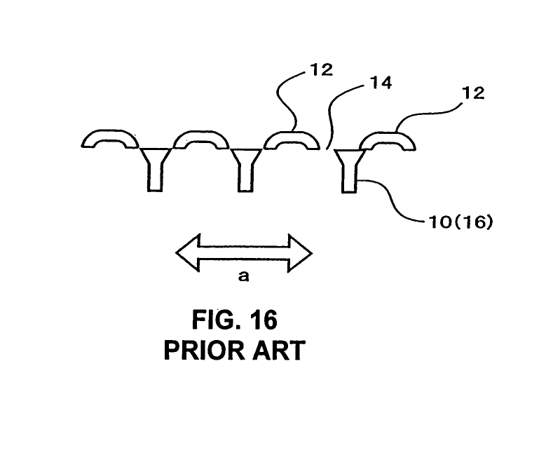

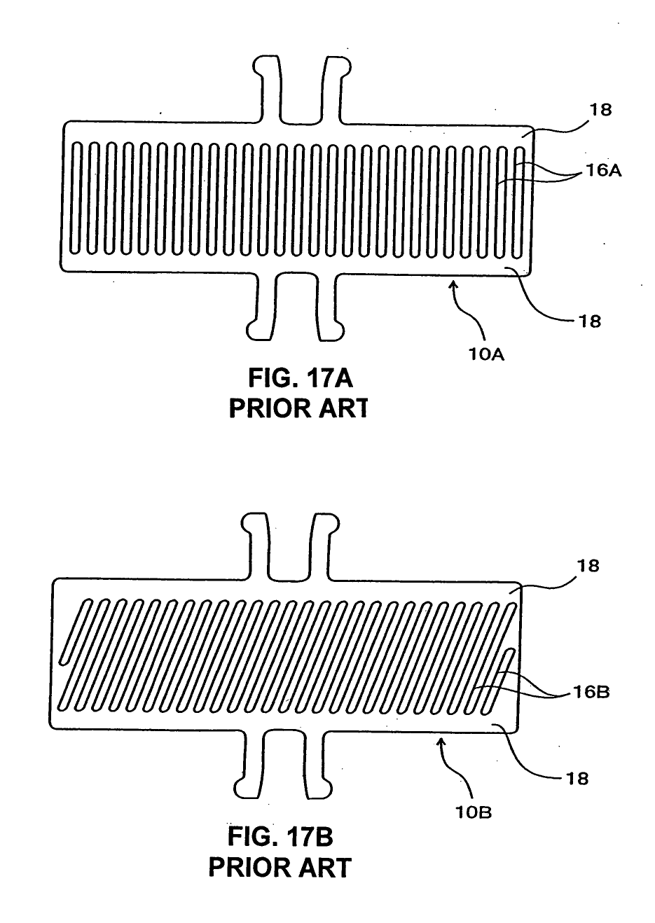

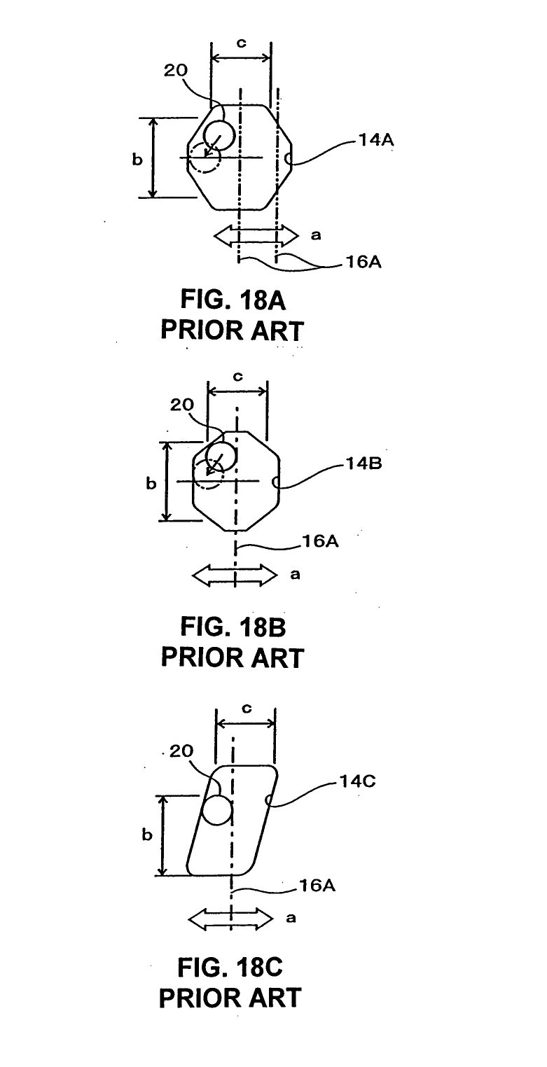

FIG. 14 shows in cross section the shaver head of a dome type electric shaver according to the present invention, and FIG. 15 shows the inner cutter used in this dome type shaver.

In FIGS. 14 and 15, the reference number 150 is a dome-shaped outer cutter, and a plurality of circular hair introduction openings (not shown) are formed in the top of this outer cutter. The outer cutter 150 is, at its outer circumference, held by a cap 152 that is screw-engaged with the shaver body (not shown).

The reference number 154 is an inner cutter. The inner cutter 154 has a substantially circular disk-form inner cutter base 156, and a plurality of cutter blades 158A through 158C are provided on this inner cutter base 156 so that these cutter blades are movable upward and downward (or in the axial direction of the inner cutter). A through-hole 160 is formed in the center of the inner cutter base 156, and the rotating output shaft of a motor (both not shown) of the shaver is engaged with this through-hole.

A return inertia that is oriented in the upward direction is applied to the cutter blades 158 by springs (not shown), so that the cutting edges of the cutter blades 158A through 158C make sliding contact with the undersurface of the outer cutter 150. As seen from FIG. 15, the shapes of the cutting edges of the adjacent cutter blades 158A through 158C are formed so that they are different from each other. More specifically, the cutting edges of the three cutter blades are a circular arc shape (158A), a peak waveform shape (158B), and a valley waveform shape (158C). Accordingly, hair entering the same or a particular hair introduction opening of the outer cutter 150 is cut by three different types of cutter blades 158 that intersect the hair introduction opening at different angles when the inner cutter rotates in the direction shown by the curved arrow in FIG. 15, so that the regions of the cutting edge of the hair introduction openings that are used during shaving can vary according to the different shapes of cutter blades 158. Accordingly, the outer cutter 150 has an extended useful life.

1. An electric shaver in which a plurality of mutually separated cutter blades provided in an inner cutter are caused to move in relative terms while making sliding contact with an outer cutter that is formed with a plurality of hair introduction openings, so that hair that is introduced into the hair introduction openings of the outer cutter is cut by said cutter blades, wherein said cutter blades are caused to intersect said hair introduction opening of said outer cutter at different angles.

2. The electric shaver according to claim 1, wherein
said shaver is a reciprocating electric shaver;
said outer cutter is made of a thin plate that is formed with a plurality of hair introduction openings and is bent in an arch shape; and
said inner cutter is made of a thin plate that is bent in an arch shape, said inner cutter being formed with a plurality of mutually separated cutter blades and side end portions that connect both ends of said cutter blades, and said inner cutter making a reciprocating motion within said arch-shaped outer cutter.

3. The electric shaver according to claim 1, wherein
said shaver is an electric rotary shaver;
said outer cutter is in a cylindrical shape having a top which is provided with a plurality of hair introduction openings formed in a substantially radial configuration; and
said inner cutter rotates while being disposed concentrically with said outer cutter.

4. The electric shaver according to claim 1, wherein
said shaver is a dome type electric shaver;
said outer cutter is a substantially dome-shaped cutter that is formed with a plurality of hair introduction openings; and
said inner cutter is comprised of an inner cutter base, which is disposed concentrically with said outer cutter and rotates, and cutter blades, which are provided on said inner cutter base in a substantially radial orientation.

5. The electric shaver according to claim 2, wherein
said cutter blades have a plurality of bent regions that have different inclinations with respect to a direction of reciprocating motion of said inner cutter; and
changeover positions of said plurality of bent regions are different in adjacent cutter blades.

6. The electric shaver according to claim 5, wherein
said changeover positions of said plurality of bent regions are located on straight lines that are inclined with respect to said direction of reciprocating motion of said inner cutter.

7. The electric shaver according to claim 5, wherein
said changeover positions of said plurality of bent regions are located on curved lines that extend in said direction of reciprocating motion of said inner cutter.

8. The electric shaver according to claim 2, wherein
deformed portions are formed in adjacent cutter blades of said inner cutter, said deformed portions being mutually offset in a direction perpendicular to a direction of reciprocating motion of said inner cutter and having different widths in said direction of reciprocating motion of said inner cutter,.

9. The electric shaver according to claim 7, wherein each of said deformed portions has a shape selected from the group consisting of a substantially circular shape, a substantially circular ring shape, a substantially diamond shape and a substantially diamond ring shape.

10. The electric shaver according to claim 2, wherein
one of two adjacent cutter blades is in a rectilinear shape that is substantially perpendicular to a direction of reciprocating motion of said inner cutter, while another of said two adjacent cutter blades has deformed portions whose width in said direction of reciprocating motion of said inner cutter differs from width of said cutter blades.

11. The electric shaver according to claim 2, wherein
one of two adjacent cutter blades is in a substantially triangular wave form shape that is substantially perpendicular to a direction of reciprocating motion of said inner cutter, while another of said two adjacent cutter blades has deformed portions whose width in said direction of reciprocating motion of said inner cutter differs from width of said cutter blades.
